(19) United States
(12) Patent Application Publication
(10) Pub. No.: US 2005/0229449 A1
(43) Pub. Date: Oct. 20, 2005

(54) Methods and apparatus for identifying a container

(76) Inventor: Lila Shepley, Glendale, MO (US)

Correspondence Address: John S. Beulick;Armstrong Teasdale LLP, Suite 2600, One Metropolitan Square, St. Louis, MO, 63102, US

(21) Appl. No.: 10/826,644

(22) Filed: Apr. 16, 2004

(51) Int. Cl. G09F 3/00

(52) U.S. Cl. 40/306

(57) ABSTRACT

A container identification system includes a fastener mechanism that is configured to extend for a length at least partially around an outer perimeter of a container, and a tag holder that is coupled to the fastener mechanism. The tag holder includes an outer surface and an inner surface. The inner surface defines a cavity within the tag holder, such that the cavity has a circumferential length that is less than the length of the fastener mechanism. The cavity is sized to receive indicia therein for identifying the container.

### BACKGROUND OF THE INVENTION

This invention relates generally to identification tags, and more particularly, to methods and apparatus for identifying a container.

Various types of identification systems for identifying containers are known. For example, identification tags may be used to identify the owner of a particular beverage at a party where multiple guests may be consuming similar beverages and/or using similar beverage containers, and as such, a person's drink could easily be confused with another person's drink when set on a coaster, for example. In addition to being impolite and/or socially unacceptable to drink from another's drink, inherent dangers may be associated with consuming another persons drink because certain diseases and/or viruses may be transferred through another's drink.

To facilitate preventing a person from inadvertently drinking from another's drink, at least some known identification systems allow a user to couple indicia thereon for identification purposes. For example, a plurality of charms may be attached to the stem of each person's glass to identify each person's drinks. However, there is a limit to the type of identifying marks that can be used, and such charms may be relatively expensive to manufacture. Alternatively, identification tags may be coupled to the beverage container to distinguish one beverage from another, however, such known systems are limited to a single use, and as such may need to be replaced frequently as the drinks are consumed.

### BRIEF DESCRIPTION OF THE INVENTION

In the exemplary embodiment of the present invention, a container identification system is provided. The system comprises a fastener mechanism configured to extend for a length at least partially around an outer perimeter of a container. The system also comprises a tag holder coupled to the fastener mechanism. The tag holder has an outer surface and an inner surface. The inner surface defines a cavity within the tag holder. The cavity has a circumferential length that is less than the length of the fastener mechanism. The cavity is sized to receive indicia therein for identifying the container.

In another exemplary embodiment of the present invention, a method of identifying a container is provided. The method comprises coupling a container identification system including a tag holder and a fastening mechanism to a container. The fastener mechanism extends for a length at least partially around an outer perimeter of the container. The tag holder has a circumferential length that is shorter than the length of the fastening mechanism. The method also comprises coupling an identification tag to the tag holder that facilitates identifying the container.

### BRIEF DESCRIPTION OF THE DRAWINGS

FIG. 1 is a perspective view of an exemplary container identification system coupled to a container;

FIG. 2 is an enlarged perspective view of a portion of the container identification system shown in FIG. 1;

FIG. 3 is a cross-sectional view of a portion of the container identification system shown in FIGS. 1 and 2 and taken along line 3-3;

FIG. 4 is a cross-sectional view of an exemplary fastener mechanism that may be used with the container identification system shown in FIGS. 1 and 2;

FIG. 5 is a partial plan view of an alternative embodiment of a portion of a container identification system that may be used with the container shown in FIG. 1; and

FIG. 6 is a cross-sectional view of another alternative embodiment of a container identification system that may be used to identify the container shown in FIG. 1.

### DETAILED DESCRIPTION OF THE INVENTION

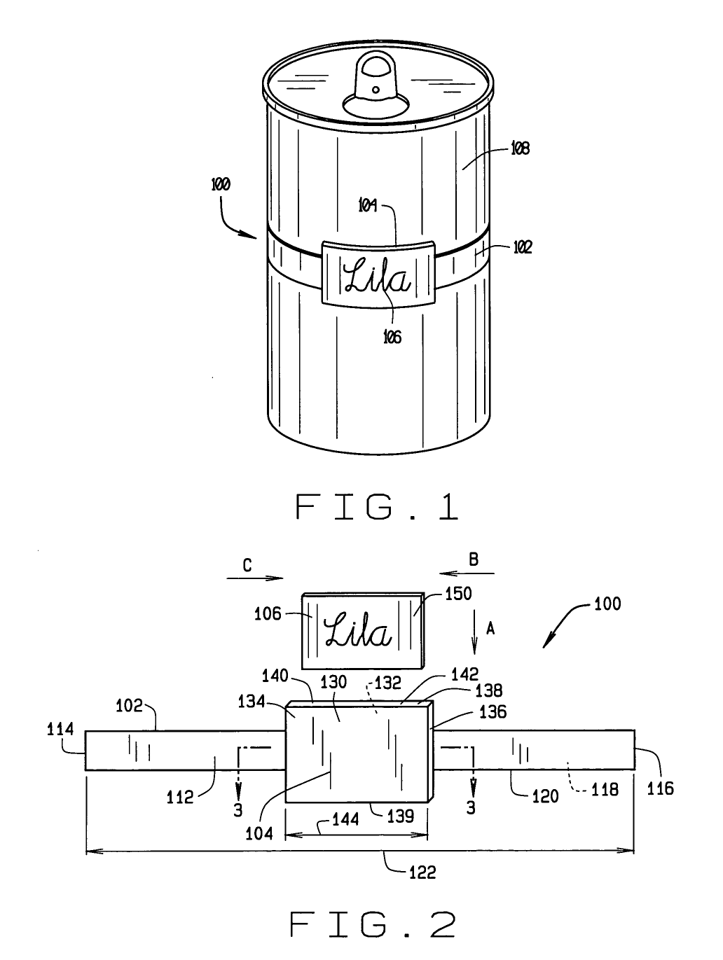

FIG. 1 is a perspective view of an exemplary container identification system 100. FIG. 2 is an enlarged view of a portion of container identification system 100 taken along area 2. Container identification system 100 includes a fastener mechanism 102, a tag holder 104, and an identification tag 106. Container identification system 100 is coupled to a container 108, such as, for example an aluminum can containing a beverage therein. In the exemplary embodiment, container 108 has a substantially circular cross sectional profile. However, other types of containers 108 can be used with the container identification system 100, such as, for example, a bottle, ajar, or a cup, and container 108 can be of any shape and size, and fabricated from a variety of materials, such as, but not limited to, glass, plastic, or metal. Moreover, it should be noted that container identification system 100 is not limited to being used with containers having a substantially circular cross sectional profile and rather, in alternative embodiments, container identification system 100 is used with containers that have non-circular cross sectional profiles.

Fastener mechanism 102 includes an elongated body 112 that extends between a first end 114 and a second end 116 for a length 122. Body 112 has an inner surface 118 and an outer surface 120, and is fabricated from a flexible material, such as, but not limited to, plastic. In the exemplary embodiment, body length 122 is longer than a length of an outer perimeter of container 108. Accordingly, in the exemplary embodiment, container identification system 100 is capable of extending around container 108. In an alternative embodiment, body length 124 is shorter than the outer perimeter length of container 108 such that fastener mechanism 102 extends only partially circumferentially around container 108. In another alternative embodiment, body length 122 is approximately equal to the outer perimeter length of container 108. In yet another alternative embodiment, fastener mechanism is stretchable such that body length 122 is adjustable to accommodate different sized containers 108.

Tag holder 104 includes an outer surface 130 and an opposite inner surface 132 that each extend between a first end 134 and an opposite second end 136. Moreover, tag holder 104 also extends between a top edge 138 and a bottom edge 139. A cavity 140 is defined within tag holder 104 and is bordered by first and second ends 134 and 136, respectively, and top and bottom edges 138 and 139, respectively. Cavity 140 is sized to receive indicia therein for identifying the container. For example, cavity 140 has a circumferential length 144 that is less than circumferential length 122 of fastener mechanism 102. Specifically, cavity 140 is sized to receive identification tag 106 at least partially therein. In the exemplary embodiment, tag holder 104 forms a sleeve around cavity 140 such that an opening 142 is defined in at least one of first end 134, second end 136, and/or top edge 138 of tag holder 104. Opening 142 enables identification tag 106 to be inserted within tag holder cavity 140. In the exemplary embodiment, tag holder outer surface 130 is transparent such that identifying indicia placed on identification tag 106 is viewable through outer surface 130 when tag 106 is positioned within cavity 140. Accordingly, outer surface 130 is fabricated from a substantially clear plastic material. In an alternative embodiment, tag holder 104 includes an opening formed in outer surface 130 that enables the indicia to be seen. In another alternative embodiment, tag holder outer surface 130 is not transparent, and rather a portion of tag 106 extends outward from cavity 140.

In the exemplary embodiment, tag holder 104 is coupled to fastener mechanism 102, as described in detail below. Alternatively, tag holder 104 is formed integrally with fastener mechanism 102. In the exemplary embodiment, tag holder 104 has a substantially rectangular shape and is substantially centered with respect to first and second ends 114 and 116 of fastener mechanism 102. In an alternative embodiment, tag holder 104 is coupled to fastener mechanism ends 114 and 116, such that container identification system 100 is coupled to container 108 by securing fastener mechanism ends 114, 116 to tag holder 104. In another alternative embodiment, tag holder 104 has a non-rectangular shape. In a further embodiment, tag holder 104 is offset with respect to either first end 114 and/or second end 116.

Identification tag 106 includes an outer surface 150 for receiving indicia thereon to identify the user or the contents of the container. In the exemplary embodiment, identification tag 106 is sized for insertion into cavity 140 such that tag outer surface 150 is visible through tag holder outer surface 130 when identification tag 106 is within into cavity 140. In an alternative embodiment, at least a portion of tag outer surface 150 remains external to cavity 140 and is thus visible when tag 106 is within cavity 140. In the exemplary embodiment, identification tag 106 is flexible to substantially contour against another surface of container 108. In the exemplary embodiment, opening 142 is defined within tag holder top edge 138 to enable access to cavity 140, and more specifically, to enable such identification tag 106 to be inserted into the cavity 140 in the direction of Arrow A. In an alternative embodiment, opening 142 is defined within at least one of tag holder first and/or second end 134 and/or 136, respectively, such that identification tag 106 may be inserted into cavity 140.

Tag outer surface 150 receives indicia thereon which facilitates identifying the user and/or the contents of container 108. In the exemplary embodiment, outer surface 150 is erasable and is fabricated from, for example, a dry erase material that includes a polypropylene coating such that identification tag is erasable and may be relabeled. In an alternative embodiment, outer surface 150 includes a disposable card which can receive identifying markings thereon, and which is replaced after each use.

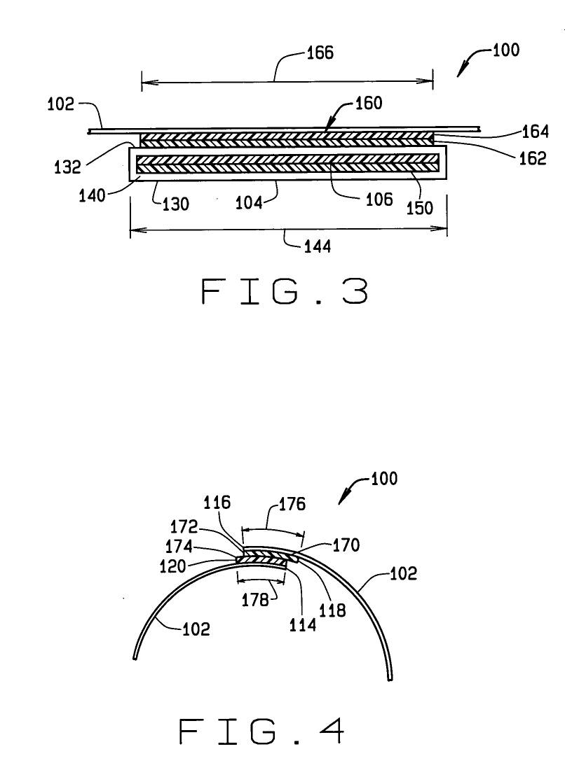

FIG. 3 is a cross-sectional view of a portion of container identification system 100 including fastener mechanism 102, tag holder 104, and identification tag 106. In the exemplary embodiment, identification tag 106 is positioned within tag holder cavity 140 such that tag outer surface 150 is visible through tag holder outer surface 130. As indicated above, tag outer surface 150 receives indicia which facilitates identifying the user and/or the contents of container 108.

Container identification system 100 also includes an attachment mechanism 160. In the exemplary embodiment, attachment mechanism 160 is a hook and loop fastener. Alternatively, other types of fasteners can be utilized, such as, for example, an interlocking device, a hook and pile fastener, a tab and slot device, a locking mechanism, a magnet, a tying system, and/or a clip. A hook portion 162 of attachment mechanism 160 is positioned on tag holder inner surface 132, and a loop portion 164 of attachment mechanism 160 is positioned on fastener mechanism outer surface 120, such that, when hook portion 162 is coupled to loop portion 164, tag holder 104 is securely coupled to fastener mechanism 102. In the exemplary embodiment, attachment mechanism 160 has a length 166 which is approximately equal to tag holder length 144. In alternative embodiments, attachment mechanism length 166 may be shorter than, or longer than tag holder length 144. In another alternative embodiment, container identification system 100 includes a plurality of attachment mechanisms 160 coupled to tag holder 104 and fastener mechanism 102 to facilitate coupling tag holder 104 to fastener mechanism 102.

FIG. 4 is a cross-sectional view of an exemplary attachment mechanism 170 that may be used with fastener mechanism 102. In the exemplary embodiment, attachment mechanism 170 is a hook and loop fastener. Alternatively, other types of fasteners can be utilized, such as, for example, an interlocking device, a hook and pile fastener, a tab and slot device, a locking mechanism, a magnet, a tying system, and/or a clip device. A hook portion 172 is positioned on fastener mechanism inner surface 118 at second end 116, and a loop portion 174 is positioned on fastener mechanism outer surface 120 at first end 114, such that, when hook portion 172 is coupled to loop portion 174, first and second ends 114 and 116 are securely coupled together such that container identification system 100 is secured to container 108. Attachment mechanism portions 172 and 174 each have a length 176 and 178 that enables fastener mechanism 102 to extend around a plurality of different sized, and different shaped, containers 108. In an alternative embodiment, first and second ends 114 and 116, respectively, are coupled together using a fastening means, such as, for example, a sewing process, such that ends 114 and 116 are permanently fixed to one another.

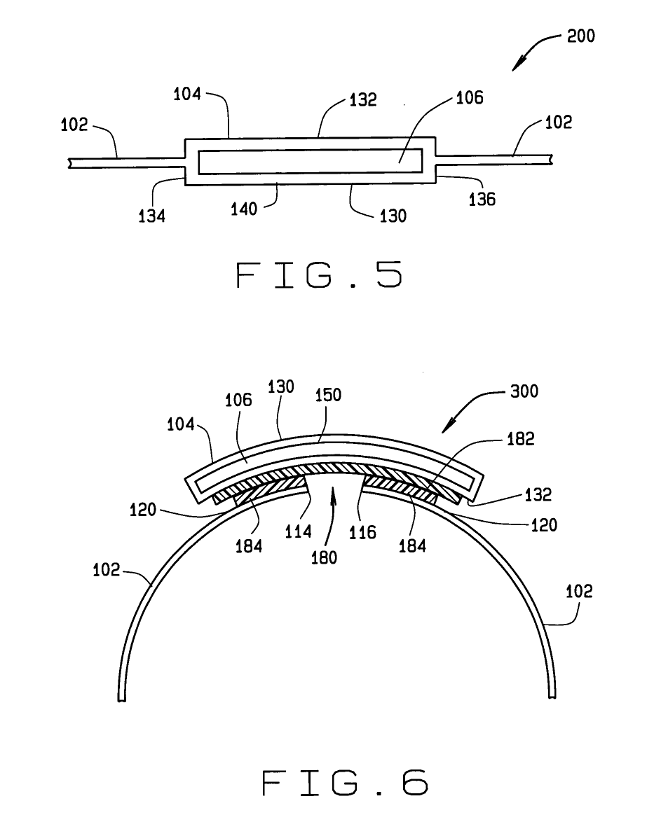

FIG. 5 is a partial plan view of an alternative embodiment of a container identification system 200 that may be used with container 108 (shown in FIG. 1). In system 200, tag holder 104 and fastener mechanism 102 are integrally formed together during fabrication. Alternatively, other tag holders 104 and fastener mechanisms 102 may be coupled together integrally using other means, such as, for example, using a chemical bonding process. In the exemplary embodiment, fastener mechanism 102 and tag holder inner surface 132 are fabricated from the same material, such as, for example, plastic, and tag holder outer surface 130 is coupled to inner surface 132 around the perimeter of outer surface 130. An opening or slot is defined within at least one of first end 134, second end 136, and/or top edge 138 (shown in FIG. 2) to enable identification tag 106 to be inserted at least partially into cavity 140. Outer surface 130 is fabricated from a substantially transparent material, such as, for example, plastic, such that identification tag 106 is at least partially visible through outer surface 130.

FIG. 6 is a cross-sectional view of another alternative embodiment of a container identification system 300 that may be used with container 108 (shown in FIG. 1). Identification tag 106 is illustrated as being inserted within tag holder 104, such that, outer surface 150 is at least partially visible through tag holder outer surface 130. Attachment mechanism 180 is a hook and loop fastener. Alternatively, other types of fasteners can be utilized, such as, for example, an interlocking device, a hook and pile fastener, a tab and slot device, a locking mechanism, a magnet, a tying system, or a clip. A hook portion 182 of attachment mechanism 180 is positioned tag holder on inner surface 132 and a loop portion 184 is positioned on fastener mechanism outer surface 120 at first and second ends 114 and 116, such that, when hook portion 182 is coupled with loop portions 184, first end 114 and second end 116 of fastener mechanism 102 are secured to tag holder 104 such that container identification system 100 is securely coupled to container 108.

The above-described container identification system is a cost-effective and highly reliable means to facilitate securing an identification tag to a container. More specifically, the identification tag is reusable and is rigidly secured to the fastener mechanism via the tag holder. The container identification system is adjustable to accommodate multiple sizes and shapes of containers.

Exemplary embodiments of container identification systems are described above in detail. The systems are not limited to the specific embodiments described herein, but rather, components of each system may be utilized independently and separately from other components described herein. Each container identification system component can also be used in combination with other container identification system components.

While the invention has been described in terms of various specific embodiments, those skilled in the art will recognize that the invention can be practiced with modification within the spirit and scope of the claims.

1. A container identification system comprising:
a fastener mechanism configured to extend for a length at least partially around an outer perimeter of a container; and
a tag holder coupled to said fastener mechanism and comprising an outer surface and an inner surface, said inner surface defining a cavity within said tag holder, said cavity having a circumferential length that is less than the length of said fastener mechanism, said cavity sized to receive indicia therein for identifying the container.

2. A container identification system in accordance with claim 1 further comprising an identification tag sized for insertion into said cavity, said identification tag configured to receive indicia thereon for identifying the container.

3. A container identification system in accordance with claim 2 wherein said identification tag comprises an erasable outer surface.

4. A container identification system in accordance with claim 3 wherein said erasable outer surface comprises a polypropylene coating.

5. A container identification system in accordance with claim 1 wherein said tag holder is formed integrally with said fastener mechanism.

6. A container identification system in accordance with claim 1 further comprising an attachment mechanism for coupling said tag holder to said fastener mechanism.

7. A container identification system in accordance with claim 6 wherein said attachment mechanism comprises at least one of a mechanical fastening device, an interlocking device, a hook and pile fastener, a hook and loop fastener, a tab and slot device, a locking mechanism, a magnet, a tying system, and a clip.

8. A container identification system in accordance with claim 1, wherein a first end of said fastener mechanism is coupled to a second end of said fastener mechanism by an attachment mechanism that comprises at least one of a mechanical fastening device, an interlocking device, a hook and pile fastener, a hook and loop fastener, a tab and slot device, a locking mechanism, a magnet, a tying system, and a clip.

9. A method of identifying a container, said method comprising:
coupling a container identification system including a tag holder and a fastening mechanism to a container, such that the fastener mechanism extends for a length at least partially around an outer perimeter of the container, and wherein the tag holder has a circumferential length that is shorter than the length of the fastening mechanism; and
coupling an identification tag to the tag holder that facilitates identifying the container.

10. A method in accordance with claim 9 wherein coupling an identification tag to the tag holder further comprises coupling an identification tag to the tag holder that includes an erasable outer surface.

11. A method in accordance with claim 10 wherein coupling an identification tag to the tag holder further comprises coupling an identification tag to the tag holder that includes an erasable outer surface having a polypropylene coating.

12. A method in accordance with claim 9 wherein coupling a container identification system to a container further comprises coupling a container identification system that includes the tag holder integrally formed with the fastener mechanism to a container.

13. A method in accordance with claim 9 wherein coupling a container identification system to a container further comprises coupling an attachment mechanism to the tag holder and to the fastener mechanism.

14. A method in accordance with claim 13 wherein coupling an attachment mechanism to the tag holder and to the fastener mechanism further comprises coupling an attachment mechanism having at least one of a mechanical fastening device, an interlocking device, a hook and pile fastener, a hook and loop fastener, a tab and slot device, a locking mechanism, a magnet, a tying system, and a clip to the tag holder and to the fastener mechanism.

15. A method in accordance with claim 9 wherein coupling a container identification system to a container further comprises coupling a first end of the fastener mechanism to a second end of the fastener mechanism by an attachment mechanism that includes at least one of a mechanical fastening device, an interlocking device, a hook and pile fastener, a hook and loop fastener, a tab and slot device, a locking mechanism, a magnet, a tying system, and a clip.
